(19) United States
(12) Patent Application Publication
(10) Pub. No.: US 2017/0017731 A1
(43) Pub. Date: Jan. 19, 2017

(54) SYSTEM AND METHOD FOR OPTIMIZING AN ARRANGEMENT OF OBJECTS FORMED FROM AT LEAST ONE STRUCTURE IN ORDER TO USE SAID OBJECTS TO DESIGN A TECHNICAL INSTALLATION

(71) Applicant: SIEMENS AKTIENGESELLSCHAFT, Munchen (DE)

(72) Inventors: PETER FIGE, MUNCHEN (DE); CHRISTOPH MOLL, MUNCHEN (DE); FARID RIAHI, MUNCHEN (DE); ANDREAS SCHIEF, MUNCHEN (DE); FLORIAN SEIPP, MUNCHEN (DE)

(21) Appl. No.: 15/189,052

(22) Filed: Jun. 22, 2016

(30) Foreign Application Priority Data
Jul. 15, 2015 (DE) 102015213302.8

(51) Int. Cl. G06F 17/50

(52) U.S. Cl. CPC G06F 17/50

(57) ABSTRACT

A system, method, and an associated computer program (product) for optimizing an arrangement of objects formed from at least one structure in order to use objects to design a technical installation is provided. The system has: a selection device for selecting objects that are filtered from a set of provided objects on the basis of properties of the objects and/or arrangement conditions derived from the relationships of the objects among one another and/or by means of prescribable parameters, a processing device designed to make an association between each selected object and at least one subarea of the technical installation, an optimization device designed to perform optimization of the arrangement of the selected objects within their subarea, if need be iteratively, by rotating and/or by tilting and/or sorting and/or rearranging the objects, an output device for outputting the optimized arrangement of the objects to use this arrangement for designing the installation.

### CROSS-REFERENCE TO RELATED APPLICATIONS

This application claims priority to German Application No. DE 102015213302.8 having a filing date of Jul. 15, 2015, the entire contents of which are hereby incorporated by reference.

### FIELD OF TECHNOLOGY

The following relates to a system and a method and also to an associated computer program (product) for optimizing an arrangement of objects formed from at least one structure in order to use said objects to design a technical installation. Embodiments of the invention relate to the field of installation engineering, e.g. in planning for traction engines and traction vehicles, e.g. for road trains and semitrailer trucks or goods trains. Other applications and installation types, such as e.g. photovoltaic devices, operating facilities for aircraft and vehicles, and chipset plans, are also possible, however.

### BACKGROUND

Installation planning areas, in which parts of an installation are planned within a bounded surface area or a bounded space, are particularly suitable. This installation planning area is subsequently called surface area planning. Thus, in the case of a traction engine, e.g. the tank, radiator, wheel suspension, wheel axles, etc. parts need to be placed in subareas of the traction vehicle that are each split e.g. into three subareas, horizontally bounded by two main supports along the underside of the traction vehicle, and e.g. vertically into subareas within the vehicle cabin and outside the vehicle cabin, if need be around the semitrailer.

Installation plans tailored to customers are a great challenge. (Large) installation plans require many complex decision processes that need to engage with one another in order to be able to come up with an overall picture of the installation to be planned. Such installation planning is normally performed with the aid of a software tool. However, the software tools normally involve only partial aspects of an installation being considered. An overall picture is frequently missing, since the interfaces between the software tools are often not defined on a standard basis and each tool has a separate descriptive depiction of installation components.

When rule-based or knowledge-based installation planning tools are used, the standard use of rules and the visual depiction of an overview of the components of the installation are difficult to implement from possibly individual planning subprocesses. In the case of the surface area planning cited above by way of example, methods for fully automated optimization of the installation design in the planning process are currently not available.

### SUMMARY

As aspect relates to overcoming the problem mentioned at the outset with regard to the optimization for the design of a technical installation.

Embodiments of the invention relate to a system for optimizing an arrangement of objects formed from at least one structure in order to use said objects for designing a technical installation, having:
a selection device for selecting objects that are filtered from a set of provided objects on the basis of properties of the objects and/or arrangement conditions derived from the relationships of said objects among one another and/or by means of prescribable parameters,
a processing device that is designed to make an association between each selected object and at least one subarea of the technical installation,
an optimization device that is designed to perform optimization of the arrangement of the selected objects within their subarea, if need be iteratively, by rotating and/or by tilting and/or sorting and/or rearranging said objects,
an output device for outputting the optimized arrangement of the objects in order to use this arrangement for designing the installation.

The installation is normally designed within a technical planning process. Preferably, embodiments of the invention can be used in connection with surface area/space planning or equipment or package planning on a bounded surface area/space or a bounded frame.

In this case, the installation may be in static or mobile form.

An object formed from at least one structure may be a geometric or two-dimensional shape, e.g. a rectangle, and/or a three-dimensional shape, e.g. a cuboid.

The cited structures can represent polygon-like structures with different kinds of characteristics, e.g. trapezium, pentagon with/without protrusion, etc., which can be divided into different groups. In other words, structures can be encapsulated in a simpler geometric object, e.g. a rectangle.

The provided objects may have been or can be allocated to different groups on the basis of the properties.

In the case of exemplary planning of the traction engines, the subcomponents to be planned, e.g. tank, radiator, wheel suspension, wheel axles, can be represented by a structure.

In this case, the structures are arranged within a frame. This frame is prescribed, or has been predefined, by the user by means of prescribable parameters, e.g. specification of the length, width and height in (kilo) meters.

Structures and objects can have properties such as e.g. round, angular, and can have functions and relationships with other structures/objects. One such function may also be a task of a subcomponent of an installation. By way of example, a subcomponent such as e.g. a load suspension in a traction vehicle can perform a particular task.

The object may be formed and/or even hierarchically assembled using interleaved structures. The structure arises from technical requirements and constraints. By way of example, certain parts of a traction vehicle can be connected to one another or fitted only at particular locations. Certain parts cannot be connected to one another.

There are arrangement conditions that arise in the example as follows, from the properties of the structures and the relationships thereof with one another:
specific structures cannot collide,
certain structures cannot overlap,
specific structures can be mounted only in particular regions of the frame,
specific structures must touch a particular location (in order to be able to be fixed or coupled).

The arrangement can represent an areal (normally two-dimensional) and/or spatial (three-dimensional) and/or temporal (one-dimensional=only temporal or four-dimensional=temporal and spatial) arrangement of the objects.

The arrangement can functionally represent a (traction) engine plan or a chipset plan.

The subarea of the installation can be made up of subcomponents of the installation interacting geometrically and/or depending on shape and/or areally and/or spatially and/or temporally and/or functionally. The interaction of these subcomponents, e.g. coupling components of the vehicles, can be obtained in the example by means of the maximum load on the rear wheel suspension or the like.

Normally, the subarea lies in the bounded frame or is identical thereto.

A further aspect of embodiments of the invention relate to a method for optimizing an arrangement of objects formed from at least one structure in order to use said objects for designing a technical installation, having the following steps:
selection of objects that are filtered from a set of provided objects on the basis of the properties of the objects and/or arrangement conditions derived from the relationships of said objects among one another and/or by means of prescribable parameters,
association of each selected object with at least one subarea of the technical installation,
if need be iterative optimization of the arrangement of the selected objects within their subarea by rotating and/or by tilting and/or by sorting and/or rearranging said objects,
output of the optimized arrangement of the objects in order to use this arrangement for designing the installation.

The method can be developed as appropriate in the manner of the system described above.

In connection with the provision of the selection of objects, the association of the selected objects and the optimization of the arrangement of said objects, what are known as solvers (problem solving software) can be used. By way of example, CPLEX is known, a program system for modeling and solving optimization problems using mathematical optimization. CPLEX provides not only a command-line-based solver but also the modeling language OPL and extensive libraries (source: de.wikipedia.org/wiki/CPLEX).

A further aspect of embodiments of the invention is an installation that ay be in static form and comprise at least one of the following components:
an automation installation,
a production installation,
a power installation,
a photovoltaic installation,
a machine.

The installation may also be in mobile form and comprise at least one of the following components:
a vehicle,
a mobile machine,
an aircraft.

These cited components can therefore specify the installation type.

The apparatus provides means/units and modules for performing the method cited above, each of which may be characterized in terms of hardware and/or in terms of firmware and/or in terms of software or as a computer program or computer program product.

A further aspect of the invention is a computer program product or a computer program having means for performing the method cited above when the computer program (product) is executed in the system or installation cited above.

The invention additionally has the following advantages:

The invention supports (fully) automated optimization.

In economic terms, time, possibly material and planning effort are saved when compiling and fitting the installation components.

Quality is improved by avoiding errors right in the planning phase. A good overview of the installation is provided by computing/ascertaining the arrangement and outputting it on a display apparatus or for further processing. The arrangement can further be adapted, corrected or extended. User interfaces can facilitate interaction with the invention.

### BRIEF DESCRIPTION

Some of the embodiments will be described in detail, with reference to the following figures, wherein like designations denote like members, wherein:

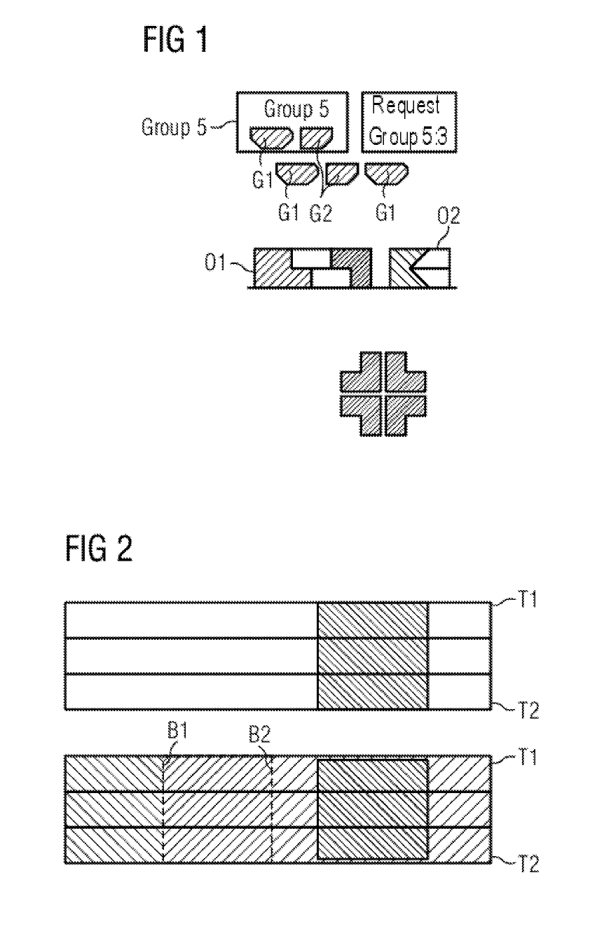

FIG. 1 shows examples of a problem that is intended to be solved and optimized;

FIG. 2 shows examples of a problem that is intended to be solved and optimized;

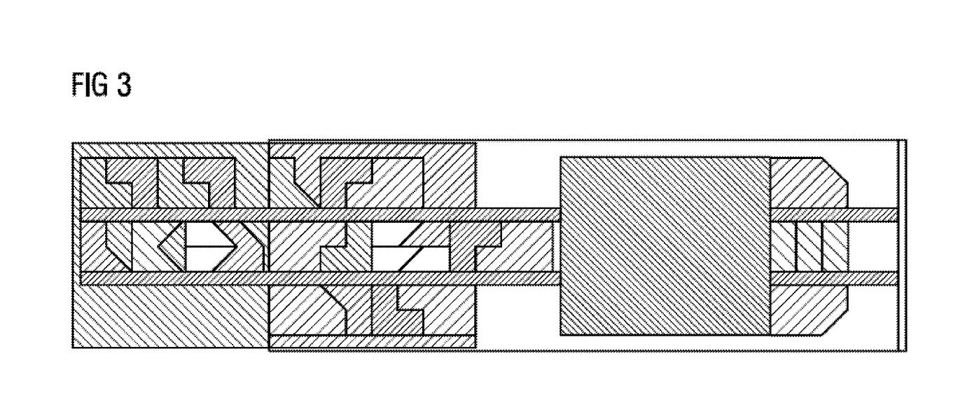

FIG. 3 shows an example of a solution to the problem;

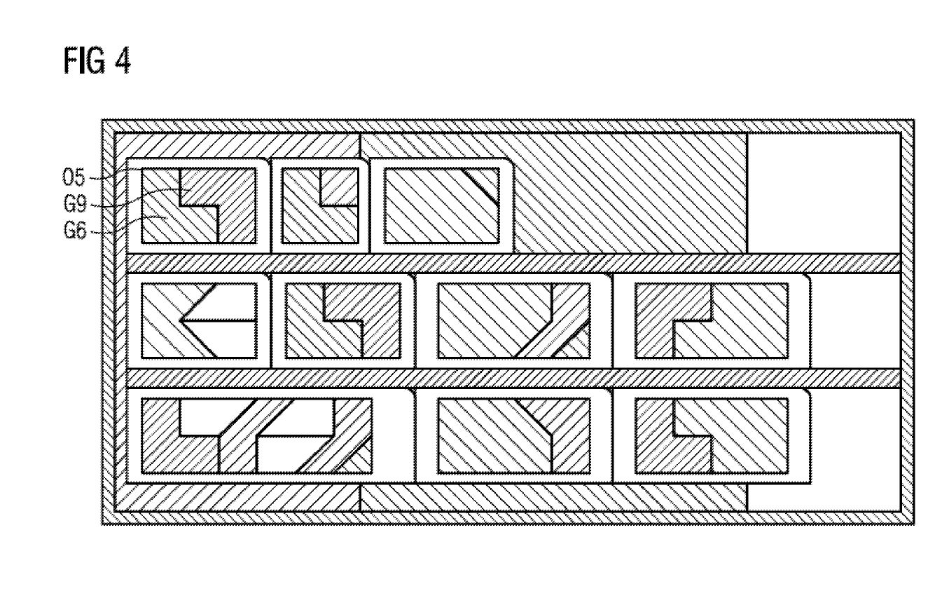

FIG. 4 shows an example of a solution to the problem;

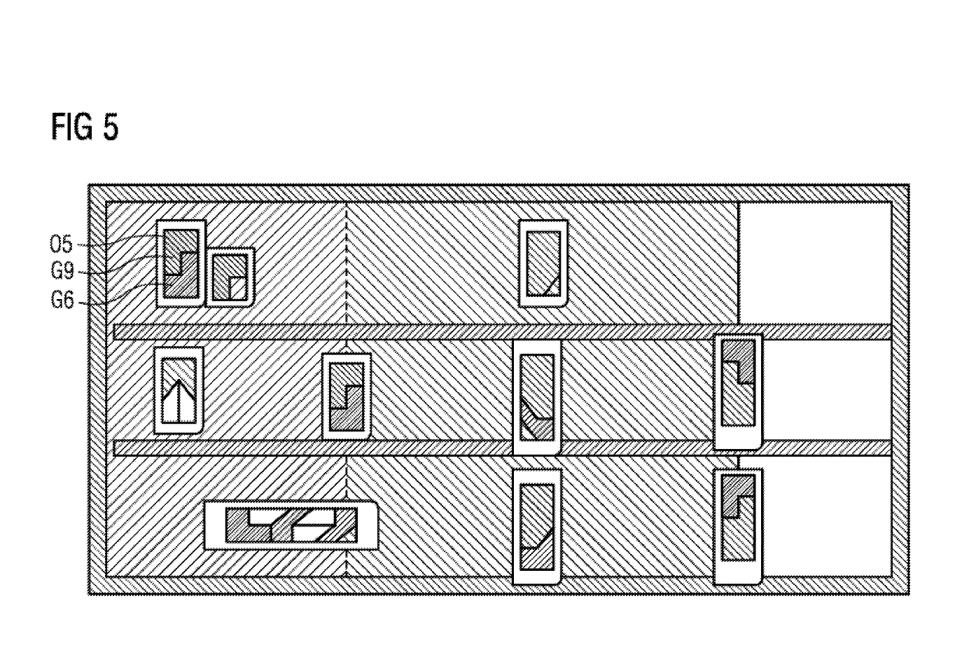

FIG. 5 shows an example of a solution to the problem;

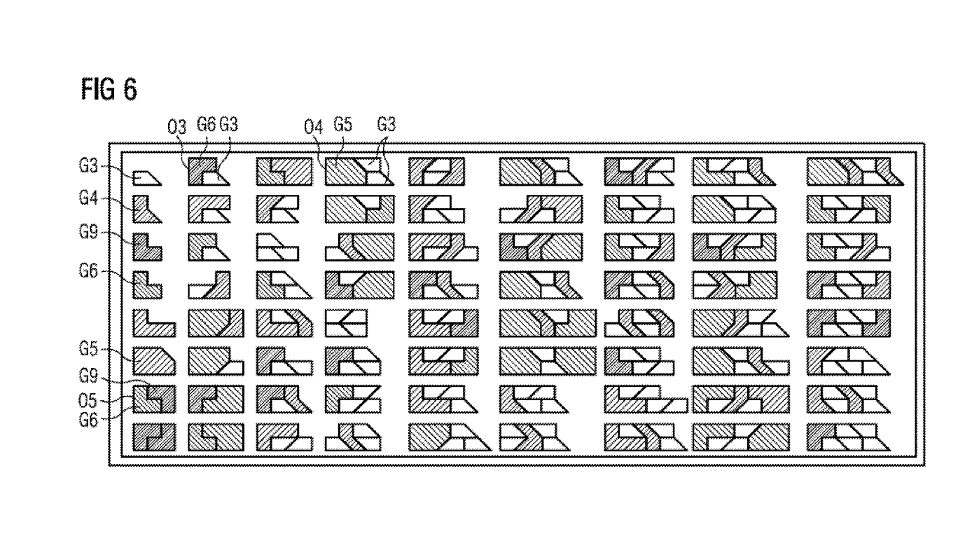

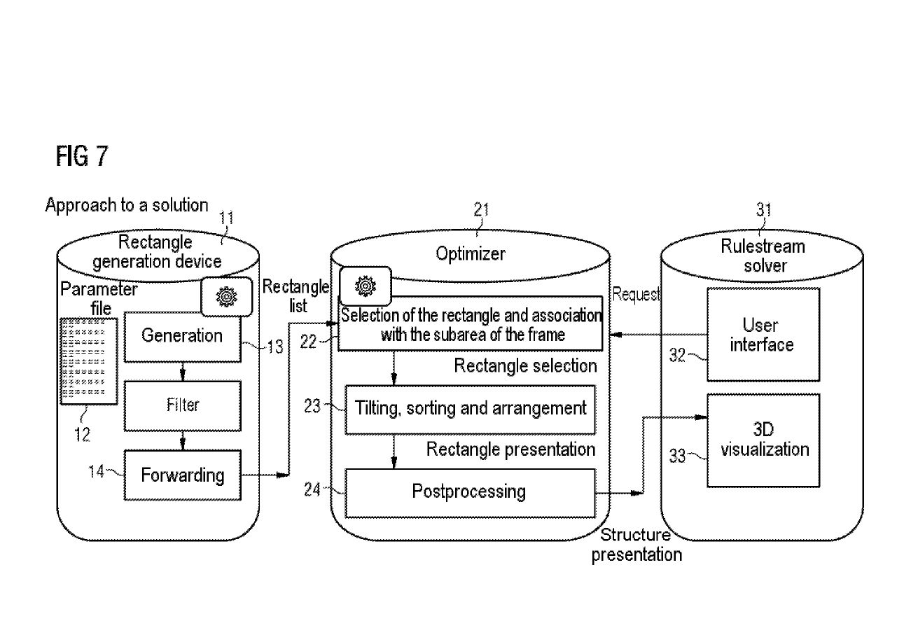

FIG. 6 shows provision of objects from which a selection is made;

FIG. 7 shows method steps and possible system devices for performing the method steps;

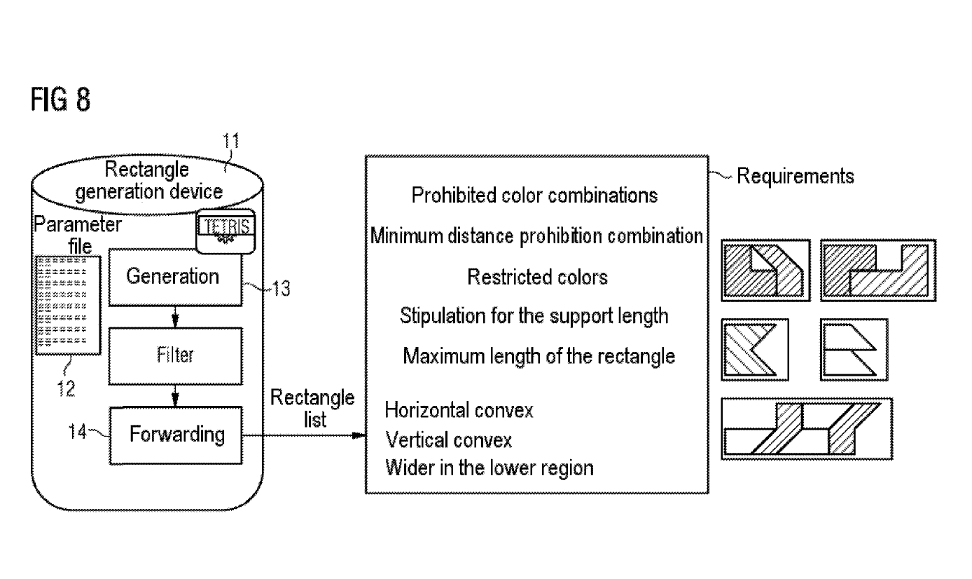

FIG. 8 shows detailed descriptions of the method steps and of the possible system devices;

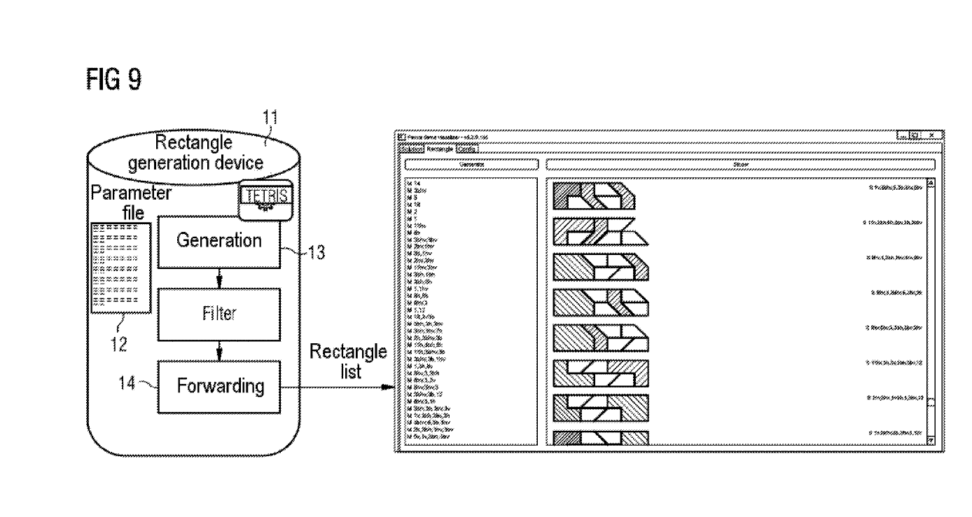

FIG. 9, shows detailed descriptions of the method steps and of the possible system devices;

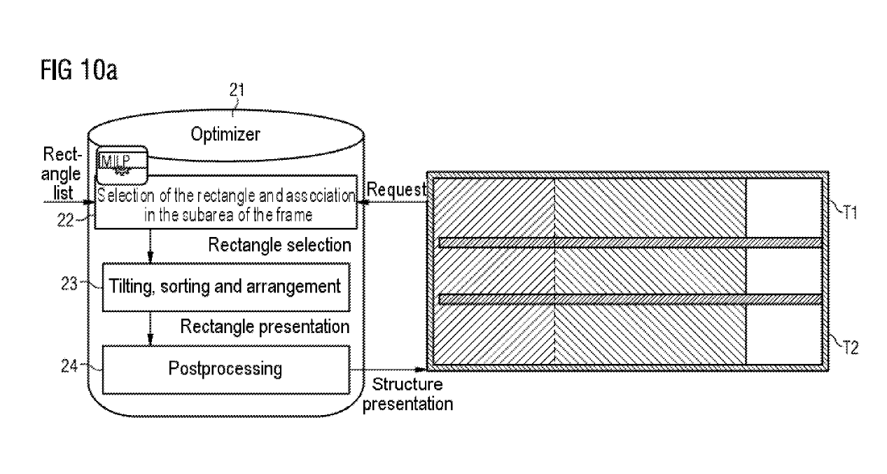

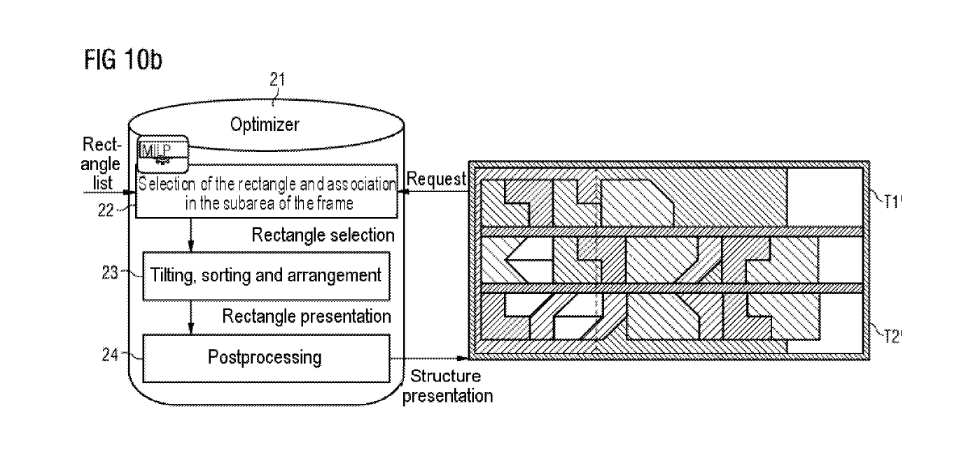

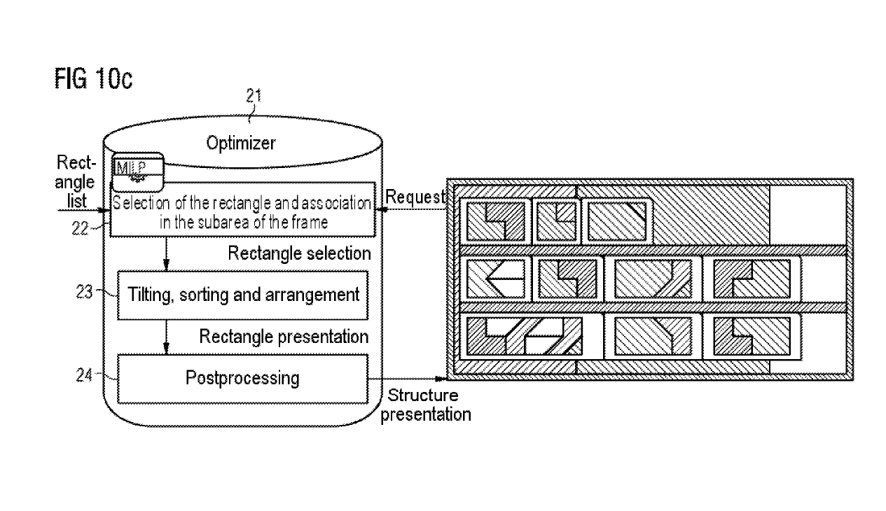

FIG. 10a shows detailed descriptions of the method steps and of the possible system devices;

FIG. 10b shows detailed descriptions of the method steps and of the possible system devices;

FIG. 10c shows detailed descriptions of the method steps and of the possible system devices;

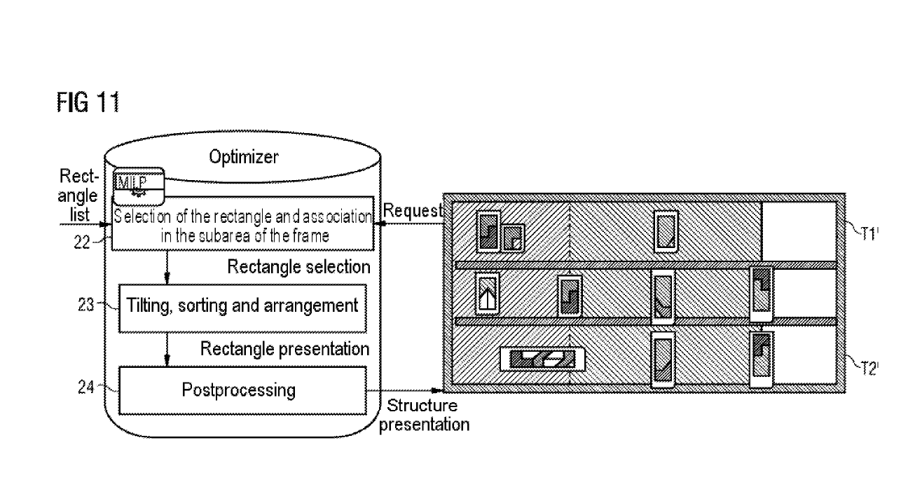

FIG. 11 shows detailed descriptions of the method steps and of the possible system devices;

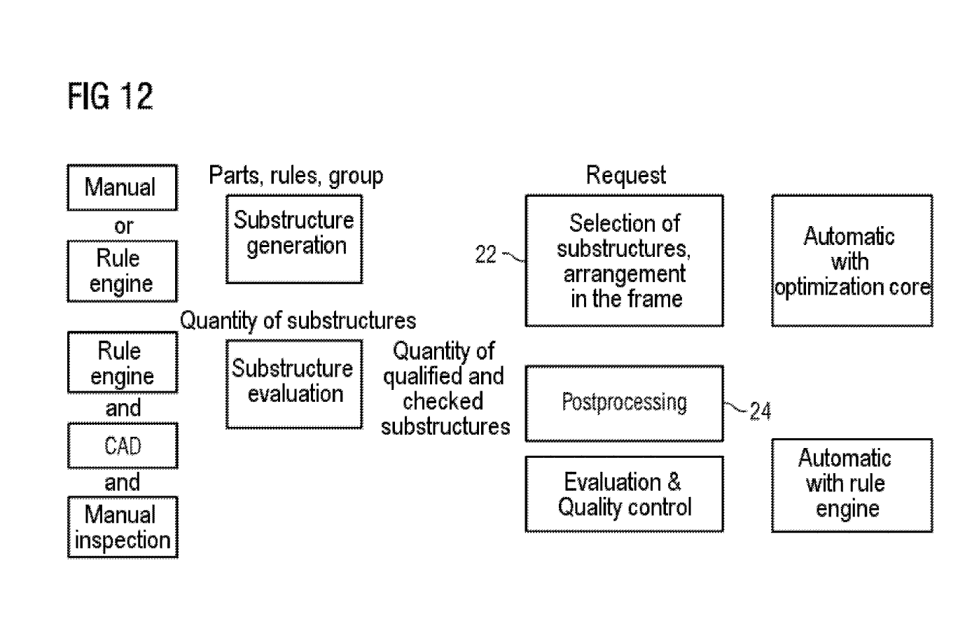

FIG. 12 shows a possible architecture for the invention;

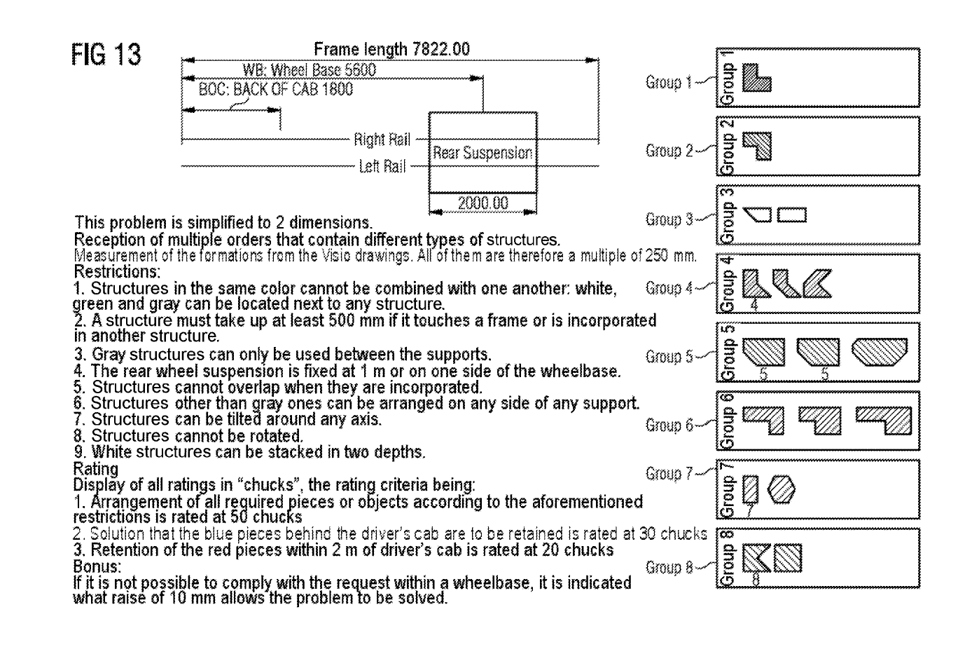

FIG. 13 show examples of a problem that is intended to be solved and optimized in accordance with embodiments of the invention; and

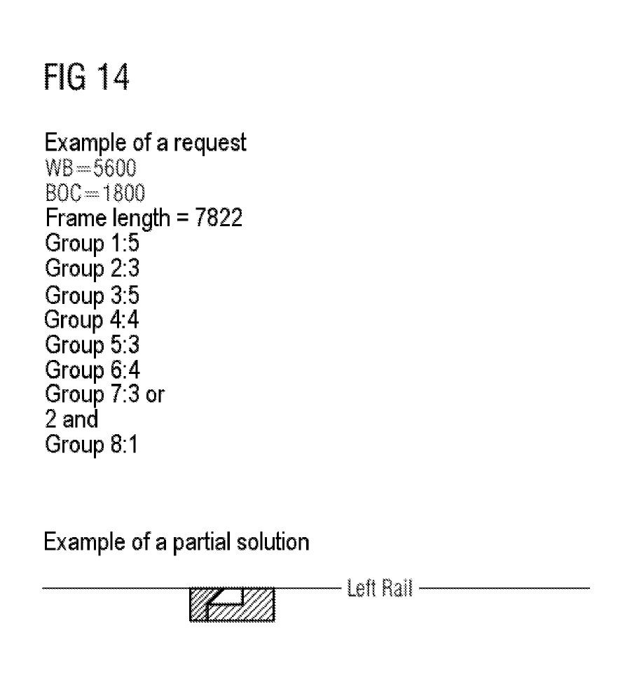

FIG. 14 shows an example of a possible partial solution.

### DETAILED DESCRIPTION

The invention is explained by way of example using a planning process for a traction vehicle. A traction vehicle, also called a truck, is normally fitted with a, possibly multiple (if permissible, trailer using a trailer mounting apparatus. The traction vehicle is intended to be designed or conceived for a customer. Parts and subcomponents such as e.g. radiator, wheel suspension, a trailer mounting apparatus, etc., are possible that are intended to be arranged or fitted in subareas T1, T2 of the traction vehicle. The placement of these subcomponents is dependent on particular fitting conditions or arrangement conditions. The subareas of the traction vehicle may be separated horizontally by two support apparatuses. Further boundaries B1, B2 for the subareas T1, T2 can be stipulated vertically, e.g. inside and outside the driver's cabin or around the trailer mounting apparatus.

In FIG. 13, the supports are indicated by right rail and left rail. One subarea indicated is the region around the rear wheel suspension, which is bounded by means of the parameters in the form of length, width and height specifications. In FIG. 2, the aforementioned subareas of the traction vehicle are indicated.

Groups Group 1, Group 2, etc., are shown that each have associated structures in the form of geometric figures, e.g. rectangle, pentagon, square with indentation, etc. By way of example, FIG. 1 shows Group 5, denoted by Group 5. This group has three associated structures, this being described by “Group 5:3”. Hence, three structures G1, G2, G3 can be taken from the Group 5, with duplicate or redundant structures, e.g. G1, being permitted. Only certain structures can be interleaved such that they produce a rectangle, that is to say an object O1, O2. The structures not only have a geometric shape, they also each have colors, e.g. white, gray, green, red, blue, yellow, etc., which can be represented in the figures only by means of different shades of gray. In FIG. 14, the Groups 1 to 8 are described by means of the number of structures associated with them, for example by means of the number 5 for Group 1, by means of the number 3 for Group 2, etc.

This compilation of the objects is subject to certain requirements:
By way of example, only white, green and gray structures can touch one another. Red and blue structures must not be directly connected to one another, for example.
Certain structures must observe a minimum distance, meaning that they cannot form a rectangle.
Certain structures can be interleaved, since they are technically couplable to one another in reality.
Certain structures or objects compiled therefrom can only be arranged in particular subareas, e.g. between the supports/hooks, etc.
Certain structures or objects compiled therefrom can only be tilted, some can only be rotated, possibly to a certain degree, and some can only be tilted and rotated, etc.
Certain structures or objects compiled therefrom cannot overlap.

FIG. 6 shows possible compilations of rectangles or objects, e.g. O3, O4, O5, from the structures, e.g. G3, G5, G6, G9. From this set of objects, each object can be provided with a weighting or the degree to which the cited requirements are met on the basis of the aforementioned requirement (see FIG. 13: chucks). Accordingly, a structure in Group 8, for example, is marked with the number 8 in FIG. 13.

On the basis of weighting, a selection of objects is made that—as shown using a subarea in FIG. 4—are each associated with the different subareas. In the optimization phase, the objects are placed and sorted and/or—as shown in FIG. 5—rotated and/or tilted, if need be afresh, while observing the above requirements and arrangements conditions.

FIG. 3 shows the outcome by way of example. It shows 3 times 5 subareas with 2 times 4 (frame) boundaries, for example. The boundaries can likewise be counted among the subareas, since they also have arrangement conditions. In some cases, the objects are permitted to cross these boundaries, and in some cases, they have to adhere to the boundaries, possibly at a certain distance. This outcome in terms of arrangement can be displayed on a display apparatus and/or made available for further processing.

FIG. 14 shows a possible partial outcome using the “left rail”.

FIG. 7 schematically shows the system according to the invention: A rectangle generator 11 can comprise the following devices, for example:
A file 12 (parameter file) that contains the parameters and requirements already explained.
A generation device 13 (generator) that generates the rectangles shown in FIG. 7 that comply with the parameters/requirements.
A forwarding device 14 (domination) that forwards the rectangle list to the optimizer 12.

The functions of the devices shown may also be combined in one device.

The optimizer, which can use the aforementioned solver, first of all has an input device that is indicated by means of the arrow denoted rectangle list. A selection device 21 is further provided that makes the selection of rectangles that has already been explained above. A processing device then assigns these rectangles to the respective subareas. The selection and processing devices may be combined in one device. An optimization device 23 optimizes the arrangement of the rectangles in their respective subareas by means of tilting, rotation, sorting and rearrangement while observing the arrangement conditions. In the denoted postprocessing 24, the outcome (see e.g. FIG. 3) is output by means of an output device, which is in turn indicated by an arrow, to a further device Rulestream Solver 31, which has previously sent the request to the optimizer via a user interface 32 Interface, and is possibly displayed on a (three-dimensional) display apparatus 33 (3D Visualization) or processed further in the Rulestream Solver.

In FIGS. 8 and 9, the requirements on the generator are presented in more detail with the possible rectangles to be provided and the rectangle list.

FIG. 10a shows the subareas T1′, T2′. FIG. 10c shows associations between the rectangles and subareas. FIG. 10b shows the outcome with possibly (re)arrangement and sorting of the rectangles.

FIG. 11 shows the outcome, i.e. the arrangement and the presentation (layout) thereof, in more detail, said outcome additionally having the tilts and/or rotations in comparison with FIGS. 3 and 10b.

FIG. 12 shows, in principle, the method steps within the context of automatic or semiautomatic handling with possibly manual intervention from the user. That is to say that the user can evaluate the list of generated rectangles (substructure evaluation) before the selection of the rectangles is made. Following the aforementioned postprocessing, the user can once again perform an evaluation and quality check.

Although the invention has been illustrated and described in more detail by means of the preferred exemplary embodiment, the invention is not restricted by the disclosed examples and other variations can be derived therefrom by a person skilled in the art without departing from the scope of protection of the invention.

1. A system for optimizing an arrangement of objects formed from at least one structure in order to use said objects to design a technical installation, comprising:
a selection device for selecting objects that are filtered from a set of provided objects on a basis of properties of the objects and/or arrangement conditions derived from the relationships of said objects among one another and/or by means of prescribable parameters;
a processing device that is designed to make an association between each selected object and at least one subarea of the technical installation;
an optimization device that is designed to perform optimization of the arrangement of the selected objects within their subarea, if need be iteratively, by rotating and/or by tilting and/or sorting and/or rearranging said objects; and
an output device for outputting the optimized arrangement of the objects in order to use this arrangement for designing the installation.

2. The system as claimed in claim 1, wherein an object formed from at least one structure can represent a geometric shape and/or a two-dimensional shape and/or a three-dimensional shape.

3. The system as claimed in claim 1, wherein the object is formed with interleaved structures.

4. The system as claimed in claim 1, wherein the arrangement represents an areal and/or spatial and/or temporal arrangement of the objects.

5. The system as claimed in claim 1, wherein the arrangement represents a traction engine plan and/or a chipset plan.

6. The system as claimed in claim 4, wherein the subarea of the installation is made up of subcomponents of the installation interacting geometrically and/or depending on shape and/or areally and/or spatially and/or temporally and/or functionally.

7. The system as claimed in claim 1, wherein the optimization of the arrangement of the objects can be performed only within a frame that is prescribable by means of the parameters.

8. The system as claimed in claim 1, wherein the aforementioned selection, association and arrangement of the objects can be performed using a problem solving system called CPLEX.

9. The system as claimed in claim 1, wherein the provided objects are allocated to different groups on the basis of the properties.

10. A static technical installation as claimed in claim 1, which comprises at least one of the following components:
an automation installation, a production installation,
a power installation,
a photovoltaic installation, and
a machine.

11. A moving technical installation as claimed in claim 1, which comprises at least one of the following components:
a vehicle,
a mobile machine, and
an aircraft.

12. A method for optimizing an arrangement of objects formed from at least one structure in order to use said objects to design a technical installation, comprising the following steps:
selection of objects that are filtered from a set of provided objects on the basis of the properties of the objects and/or arrangement conditions derived from the relationships of said objects among one another and/or by means of prescribable parameters;
association of each selected object with at least one subarea of the technical installation;
if need be iterative optimization of the arrangement of the selected objects within their subarea by rotating and/or by tilting and/or by sorting and/or rearranging said objects; and
output of the optimized arrangement of the objects in order to use this arrangement for designing the installation.

13. The method as claimed in claim 1, wherein an object formed from at least one structure represents a geometric shape and/or a two-dimensional shape and/or a three-dimensional shape.

14. The method as claimed in claim 1, wherein the object is formed with interleaved structures.

15. The method as claimed in claim 1, wherein the arrangement represents an areal and/or spatial and/or temporal arrangement of the objects.

16. The method as claimed in claim 1, wherein the arrangement represents a traction engine plan and/or a chipset plan.

17. The method as claimed in claim 1, wherein the subarea of the installation is made up of subcomponents of the installation interacting geometrically and/or depending on shape and/or areally and/or spatially and/or temporally and/or functionally.

18. The method as claimed in claim 1, wherein the optimization of the arrangement of the objects is performed only within a frame that is prescribed by means of the parameters.

19. The method as claimed in claim 1, wherein the aforementioned provision of the selection, the association and the arrangement of the objects is performed using a problem solving system called CPLEX.

20. The method as claimed in claim 1, wherein the provided objects are allocated to different groups on the basis of the properties.

21. A computer program product having means for performing the method of operation as claimed in claim 12.
